(19) United States
(12) Patent Application Publication
(10) Pub. No.: US 2011/0291518 A1
(43) Pub. Date: Dec. 1, 2011

(54) ROTOR ASSEMBLY FOR A GENERATOR OR A MOTOR

(75) Inventor: Joseph B. McCabe, Jackson, TN (US)

(73) Assignee: Emerson Electric Company

(21) Appl. No.: 12/790,463

(22) Filed: May 28, 2010

(51) Int. Cl. H02K 3/487

(52) U.S. Cl. 310/214

(57) ABSTRACT

A rotor assembly for a generator includes a rotor hub, a first rotor pole, a second rotor pole, and an element (e.g., wedge). Each rotor pole extends from the rotor hub, and includes a winding of conductive wire coupled thereto and a pole head. The pole head is positioned on an end of the rotor pole opposite to the hub, and the pole head has an arcuate outer periphery. The element is positioned between the first and second rotor poles, and includes an open volume and an aperture. The open volume is formed in the element, and is positioned proximate to the windings of the first and second rotor poles. The aperture is on an outside portion of the element, and provides access to the open volume such that air may travel to and from the open volume for cooling of the rotor assembly. The outside portion of the element is substantially flush with at least one of the pole heads, and is contoured to continuously extend the arcuate outer periphery of the at least one of the pole heads.

### BACKGROUND

The present disclosure relates generally to the field of electrical generators and/or motors. More specifically the present disclosure relates to a rotor assembly for a generator or a motor.

Working components of an electrical generator typically include a rotor designed to rotate relative to a stator. The rotor is formed from a stack of laminates (or a solid body) and includes two or more poles. The poles extend from a central hub or shaft of the rotor and include a coil of conductive wires wound around each pole for control of an electromagnetic field. As a mover, such as a diesel engine, rotates the rotor relative to the stator, alternating or direct current is produced and may be output from the generator. The same or a similar configuration may be used in reverse as an electric motor when alternating or direct current is supplied to the working components. The efficiency of a given generator or motor may be measured as a function of a variety of factors, including the percentage of mechanical energy converted to electricity (or vice versa), the useable life of the generator or motor relative to the cost of repair or replacement, and other such factors or combinations of factors.

### SUMMARY

One embodiment of the invention relates to a rotor assembly for a generator or an electric motor. The rotor assembly includes a rotor hub, a first rotor pole, a second rotor pole, and an element (e.g., wedge). The rotor assembly may include additional poles. Each rotor pole extends from the rotor hub, and includes a winding of conductive wire coupled thereto and a pole head. The rotor pole and rotor hub may be integrally formed. The pole head is positioned on an end of the rotor pole opposite to the hub, and the pole head has an arcuate outer periphery. The element is positioned between the first and second rotor poles, and includes an open volume and an aperture. The open volume is formed in the element, and is positioned proximate to the windings of the first and second rotor poles. The aperture is on an outside portion of the element, and provides access to the open volume such that air may travel to and from the open volume for cooling of the rotor assembly. The outside portion of the element is substantially flush with at least one of the pole heads, and is contoured to continuously extend the arcuate outer periphery of the at least one of the pole heads.

Another embodiment of the invention relates to an element for a rotor assembly of a generator or a motor. The element includes a first portion, a second portion, and a constraining member. The first portion is associated with a first rotor pole of the rotor assembly, and the second portion is associated with a second rotor pole of the rotor assembly. Each of the first and second portions of the element include a first side and a second side. The first side is configured to secure a conductive wire winding of the respective rotor pole, and the second side has an extension projecting therefrom toward the other of the first or second portions of the element. The extension has an arcuate section of the periphery thereof, which is contoured to continue a rounded periphery of the respective rotor pole. The constraining member is connected intermediate to the first and second portions of the element, and is configured to load the first and second portions of the element relative to the respective rotor poles.

Yet another embodiment of the invention relates to a generator or motor, which includes a stator and a rotor assembly. The rotor assembly is coupled to the stator and is configured to rotate relative thereto. The rotor assembly includes a rotor hub, a first rotor pole, a second rotor pole, and an element. Each rotor pole extends from the rotor hub and includes a winding of conductive wire coupled thereto. Each rotor pole further includes a pole head positioned on an end of the rotor pole opposite to the hub. The pole head has an arcuate outer periphery. The element of the rotor assembly includes a first portion associated with the first rotor pole, a second portion associated with the second rotor pole, and a constraining member. The constraining member is connected intermediate to the first and second portions of the element, and is configured to load the first and second portions relative to the respective rotor poles. Each of the first and second portions of the element include a first side and a second side. The first side is configured to secure the conductive wire winding of the respective rotor pole, and the second side has an extension projecting therefrom toward the other of the first or second portions of the element. The extension has an arcuate section of the periphery thereof, which is configured to extend the curvature of the arcuate outer periphery of the pole head of the respective rotor pole.

Still another embodiment of the invention relates to a generator or a motor, which includes a stator and a rotor assembly. The rotor assembly is coupled to and configured to rotate relative to the stator. The rotor assembly includes a rotor hub, a first rotor pole, a second rotor pole, and an element. Each rotor pole extends from the rotor hub and includes a winding of conductive wire coupled thereto. Each rotor pole further includes a pole head positioned on an end of the rotor pole opposite to the hub. The pole head has an arcuate outer periphery. The element is positioned between the first and second rotor poles, and includes an open volume formed therein and an aperture on an outside portion of the element. The aperture provides access to the open volume of the element such that air may travel to and from the open volume for cooling of the rotor assembly. At least one of the element and a pole head includes an arcuate section configured to extend the curvature of the arcuate outer periphery of the pole head of the respective rotor pole over the open volume formed in the element.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a generator according to an exemplary embodiment of the invention.

FIG. 2 is a perspective view of a stator assembly according to an exemplary embodiment of the invention.

FIG. 3 is a perspective view of a rotor assembly according to an exemplary embodiment of the invention.

FIG. 4 is a top view of a laminate for a rotor assembly according to an exemplary embodiment of the invention.

FIG. 5 is a side view of the laminate of FIG. 4.

FIG. 6 is a top view of a laminate with coils for a rotor assembly according to an exemplary embodiment of the invention.

FIG. 7 is a side view of the laminate with coils of FIG. 6.

FIG. 8 is a top view of an element for a rotor assembly according to an exemplary embodiment of the invention.

FIG. 9 is a top view of an element for a rotor assembly according to another exemplary embodiment of the invention.

FIG. 10 is a top view of an element for a rotor assembly according to yet another exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

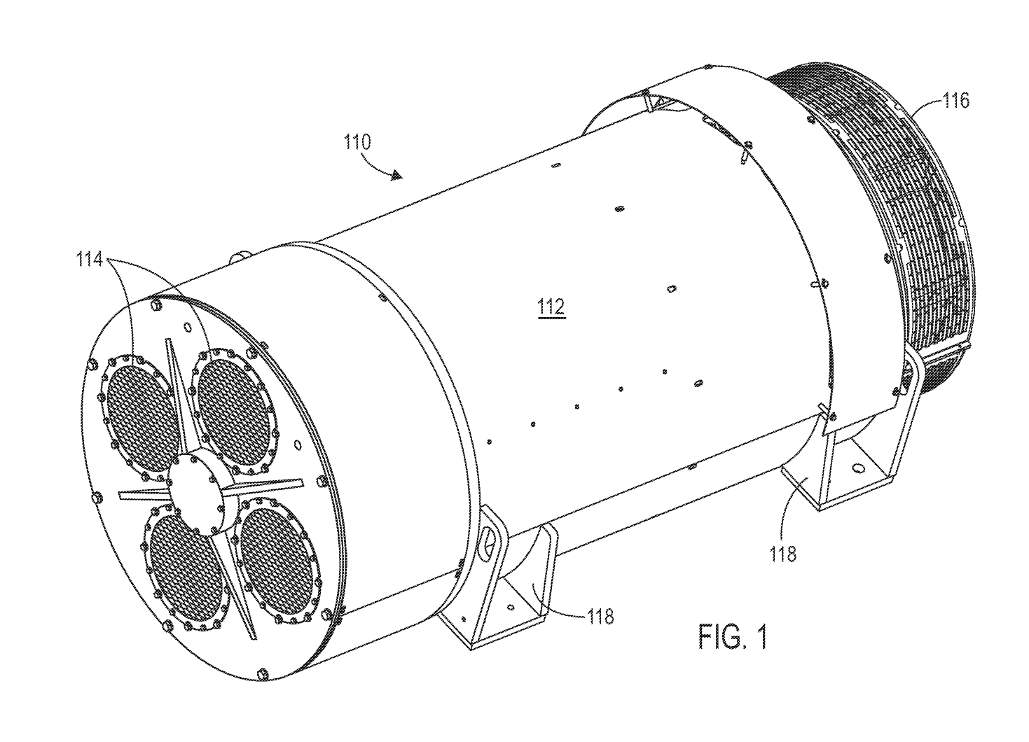

Referring to FIG. 1, a generator 110 (e.g., alternator, salient pole machine, engine-generator set or genset) includes a housing 112 containing working components of the generator 110. Grated or filtered air intakes 114 and vents 116 on the housing 112 allow for air to flow into and out of the interior of the housing 112, to cool the working components. In some embodiments, the housing 112 is formed from various pieces bolted together, and includes supports 118 configured to be fastened to a fixed location, such as a powerhouse floor.

In other embodiments, other forms, shapes, and configurations of commercially-available generators and/or electric motors may be used. In some such embodiments, a generator is coupled to a diesel engine, a gas or water turbine, or another form of mover that supplies mechanical energy to the generator to be converted to electricity. According to an exemplary embodiment, the generator 110 is configured to produce between approximately 1 to 4 megawatts (MW) of power. However in other embodiments, a generator is configured to produce less than 1 MW of power, while in other embodiments a generator is configured to produce more than 4 MW, such as power on the order of 15 to 20 MW. Further description of a generator and components thereof is provided by U.S. application Ser. No. 11/866,071, filed Oct. 2, 2007, incorporated herein by reference in its entirety.

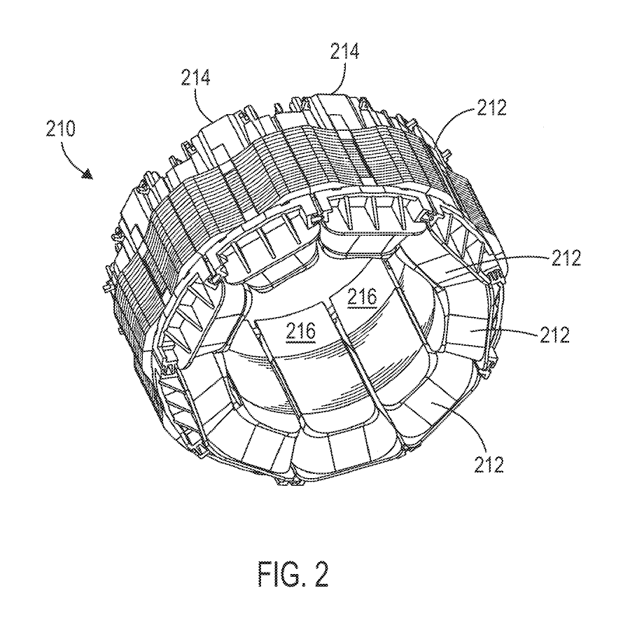

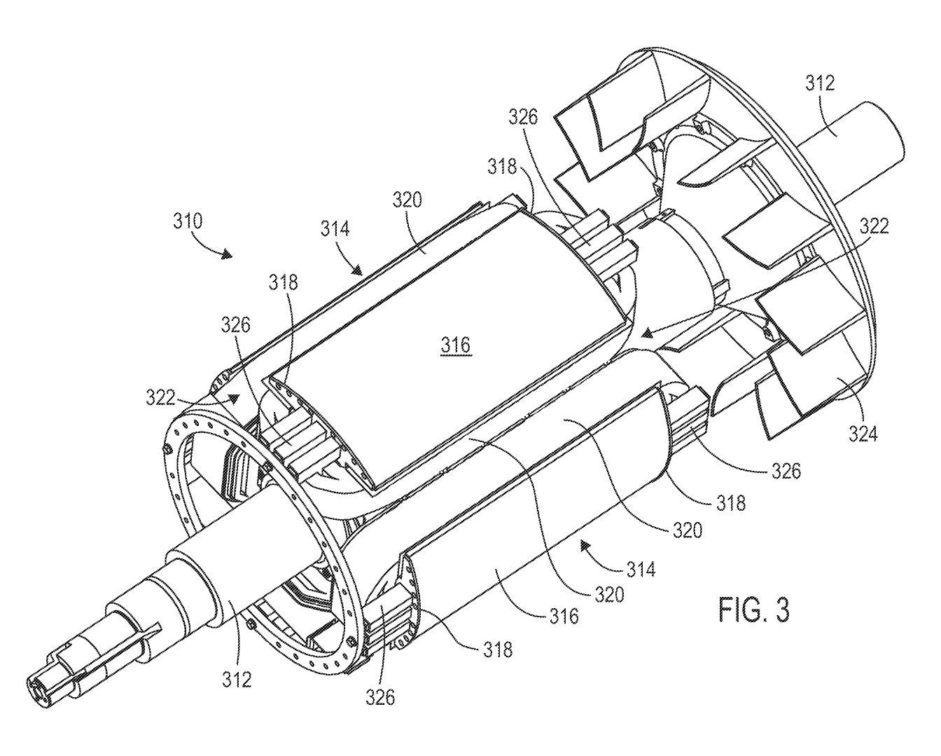

Referring to FIGS. 2-3, working components of a generator, such as the generator 110 of FIG. 1, include a stator assembly 210 (FIG. 2), which may be fixedly integrated with a housing (see, e.g., housing 112 as shown in FIG. 1) of the generator, and a rotor assembly 310 (FIG. 3) (e.g., rotor, rotating field assembly, revolving field, field magnet) configured to rotate within the stator assembly 210, or another stator assembly. In some embodiments, the rotor assembly 310 functions as an armature and the stator assembly 210 functions as a field magnet, and in other embodiments rotor assembly 310 functions as a field magnet and the stator assembly 210 functions as an armature.

According to an exemplary embodiment, the stator assembly 210 is a segmented stator, and includes several segments 212 coupled together. The segments 212 include end plates 214 and teeth 216, and may additionally include windings. In some embodiments, two or more stator assemblies may be arranged lengthwise within the housing of a corresponding generator and operated in tandem. In other embodiments, other forms, shapes, and configurations of commercially-available stator assemblies may be used. Further description of a stator assembly of a generator and components thereof is provided by U.S. Pat. No. 7,586,231, filed Aug. 18, 2008, incorporated herein by reference in its entirety.

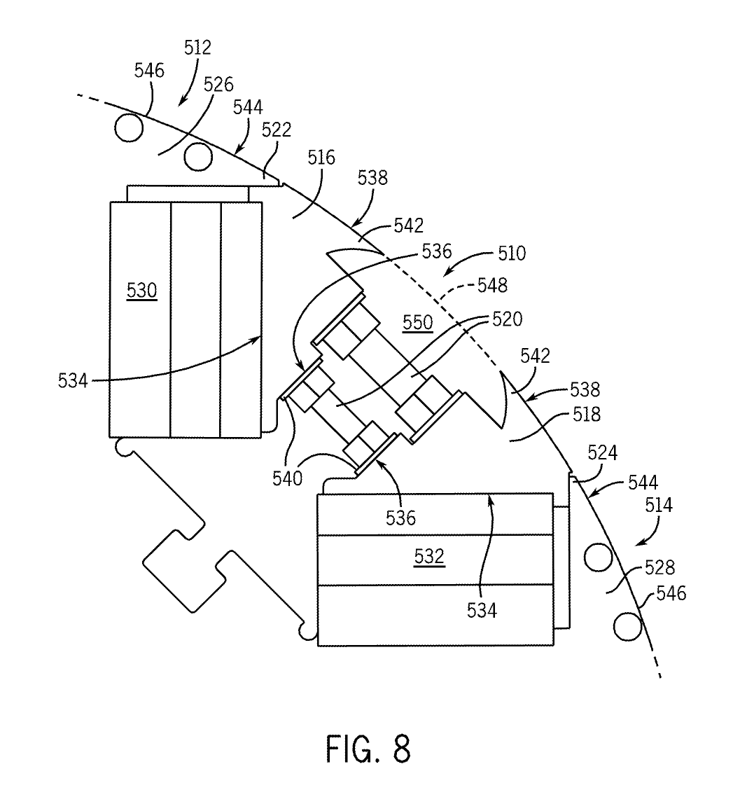

Referring now specifically to FIG. 3, the rotor assembly 310 includes a shaft 312 about which rotor poles 314 extend. Pole heads 316 extend from the end of each of the rotor poles 314. According to an exemplary embodiment, the pole heads 316 have a curved or arcuate section 318 along their outer periphery, opposite to the shaft 312. Coils 320 of conductive wire (e.g., copper wire, windings) are wound around each of the poles 314, constrained by the pole heads 316 and support bars 326. Open areas 322 are formed between the poles 314, allowing air to circulate to the coils 320. A blower fan 324 is coupled to the shaft 312, to direct a flow of air through the open areas 322 for cooling the rotor assembly and the overall generator. As will be further explained, an element (e.g., wedge, component, piece, aerodynamic structure; see, e.g., elements 510, 610, 710 as shown in FIGS. 8-10, respectively) may be inserted into the open area 322 to further constrain the coils 320.

According to an exemplary embodiment, the rotor assembly 310 is a four-pole rotor. By way of non-limiting example, in some embodiments the rotor assembly 310 rotates within a generator at a speed of about 1500 revolutions per minute (RPM) or about 1800 RPM, during operation. In other embodiments, a generator rotates at speeds less than 1500 RPM, between 1500 to 1800 RPM, and/or greater than 1800 RPM. In still other embodiments, other lengths, configurations, rotational speeds, or numbers of poles (e.g., six, eight, sixteen, etc.) may be used with a rotor assembly for a generator or an electric motor.

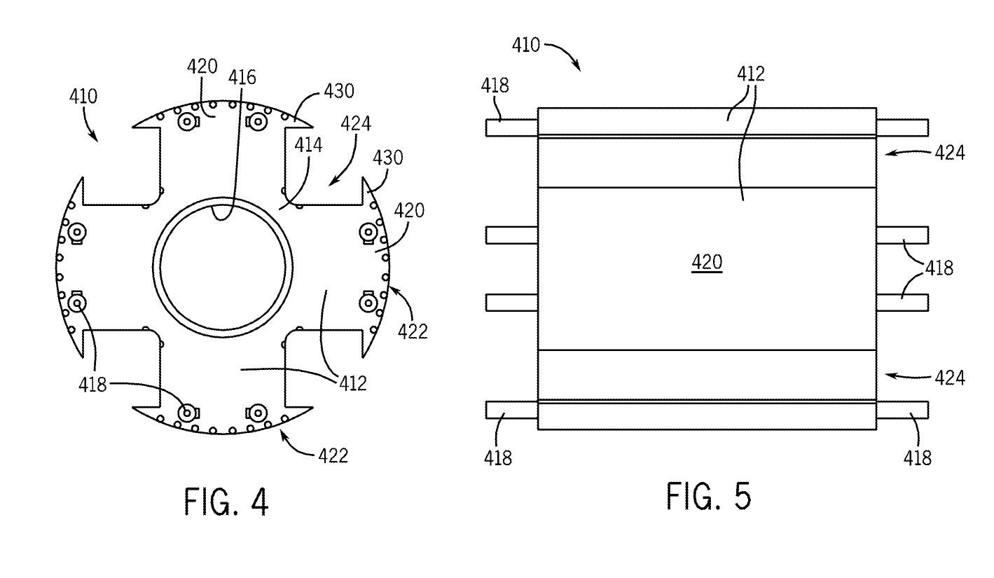

Referring now to FIGS. 4-5, a rotor assembly (see also rotor assembly 310 as shown in FIG. 3) may in part be assembled by stacking, aligning, and coupling individual lamination to form a laminate 410 (e.g., stacked sheets) as a core of the rotor assembly. Each lamination may be stamped from sheet metal (e.g., steel), or otherwise formed, generally in the shape of a cross section of the rotor assembly (e.g., four poles 412 integrally connected to a hub 414 as a single piece). By way of non-limiting example, in some embodiments each lamination is about 0.025 inches thick, and the combined laminate 410 is approximately 30 inches thick. In other embodiments, a rotor may be formed from laminations that are greater than 0.025 inches thick (e.g., 0.05 inches), less than 0.025 inches thick (e.g., 0.015 inches), combinations of laminations having different thicknesses, and/or as a single solid piece, without used of stacked laminations.

The laminate 410 includes an aperture 416 in the hub 414 for a shaft (see, e.g., shaft 312 as shown in FIG. 3) to be inserted therethrough. Coil support bars 418 (e.g., bolts, shafts, pins) hold the laminations together, forming surfaces on the laminate 410 upon which conductive wires (see, e.g., coils 320 as shown in FIG. 3) may be coiled. Open areas 424 are formed between or defined by the poles 412.

Referring to FIG. 4, on the ends of each pole 412, a pole head 420 includes an arcuate section 422 that is part of the periphery of the pole head 420. In some such embodiments, the arcuate section 422 is rounded outward (e.g., convex) with respect to the hub 414. According to an exemplary embodiment, each arcuate section 422 of each pole 412 defines an arc of approximately the same circle. Accordingly, extrapolating from the curvature of the arcuate sections 422 between the open areas 424 would form a complete circle. In other words, the outermost periphery of each pole head 420 is contoured to have a constant radius, and each of the pole heads 420 have the same radius, according to an exemplary embodiment. A circular arc for the arcuate section 422 of each pole head 420 is believed to provide an efficient curvature to reduce windage or drag losses. However in other embodiments, the arcuate sections 422 of the pole heads 420 may have a noncircular curvature and the pole heads do not have the same radius. In some such other embodiments, the pole heads (e.g., lobes) have outside-periphery radii that are less than the cross-sectional width of the rotor. In other such embodiments, the pole heads have outside-periphery radii that are radii that are greater than the cross-sectional width of the rotor. Further, the pole heads may not share the same curvature as other pole heads.

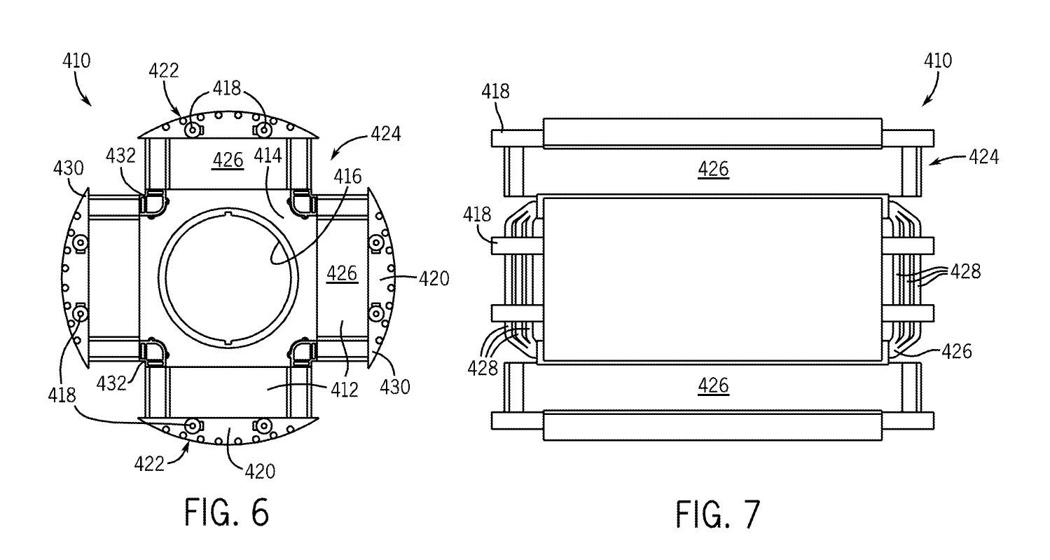

Referring to FIGS. 6-7, the laminate 410 of FIGS. 4-5 further includes coils 426 of conductive wire (e.g., windings) wound around each of the poles 412, between the respective pole head 420 and the hub 414. According to an exemplary embodiment, the pole heads 420 include a flange 430 (e.g., lip, extension) configured to at least partially constrain the coils 426. In some embodiments, the coils 426 are coupled to the poles 412 in distinct layers 428 (e.g., plies). Forces generated by rotation of the rotor assembly act upon the coils 426, which are bound and at least partially constrained by the pole heads 420, the hub 414, and the tightness of the coils 426 themselves. Additional support structure 432 (see also elements 510, 610, 710 as shown in FIGS. 8-10) may be applied to and/or between the coils 426, as a further constraint.

The open areas 424 between the poles 412 provide spaces through which air may be used to cool the coils 426 and other parts of the rotor assembly. However as the rotor assembly rotates within the stator, the open areas 424 also provide sources of drag or windage—adversely influencing the efficiency of the generator by reducing the ratio of mechanical energy converted to electricity (or vice versa with an electric motor).

According to an exemplary embodiment, elements (see e.g., elements 510, 610, 710 as shown in FIGS. 8-10) may be attached within each of the open areas 424 between poles 412 of the rotor assembly, extending lengthwise along the rotor assembly. The elements may be used simultaneously to reduce windage or drag losses that would otherwise be caused by the open areas 424 and to further constrain the coils. In addition the elements allow air to flow proximate to the coils 426, for cooling of the rotor assembly.

Referring to FIG. 8, an element 510 for placement between poles 512, 514 of a rotor assembly (see, e.g., rotor assembly 310 as shown in FIG. 3) includes a first portion 516 (e.g., member, side), a second portion 518, and a constraining member 520 (e.g., tightening member, fastener). The element 510 extends longitudinally along the rotor assembly. In some embodiments, the constraining member 520 may be a spreader bolt, a separator, a telescoping member, or a threaded member (e.g., screw, nut and bolt, rivet, etc.) coupled to both the first and second portions 516, 518 of the element 510. In some embodiments a constraining member may be formed from a supplemental element or cup to be inserted between the first and second portions 516, 518. The supplemental element may be bolted into the support structure (see, e.g., support structure 432 as shown in FIG. 6), where the bolt is longitudinally aligned toward the center of the rotor. In other embodiments, other forms of constraining members may be used.

During manufacturing of the rotor assembly, the element 510 is inserted into the open area (see, e.g., open area 322 as shown in FIG. 3; open area 424 as shown in FIG. 6) between the poles 512, 514 of the rotor assembly. The constraining member 520 is used to move the first and second portions 516, 518 of the element 510 under flanges 522, 524 of corresponding pole heads 526, 528 and against the coils 530, 532, locking the element 510 in place and helping to constrain the coils 530, 532. Although shown in FIG. 8 to fill a 90-degree angle between poles 512, 514, in other embodiments, an element may be configured for a broad range of angles, as may be used with rotor assemblies having more or fewer than four poles.

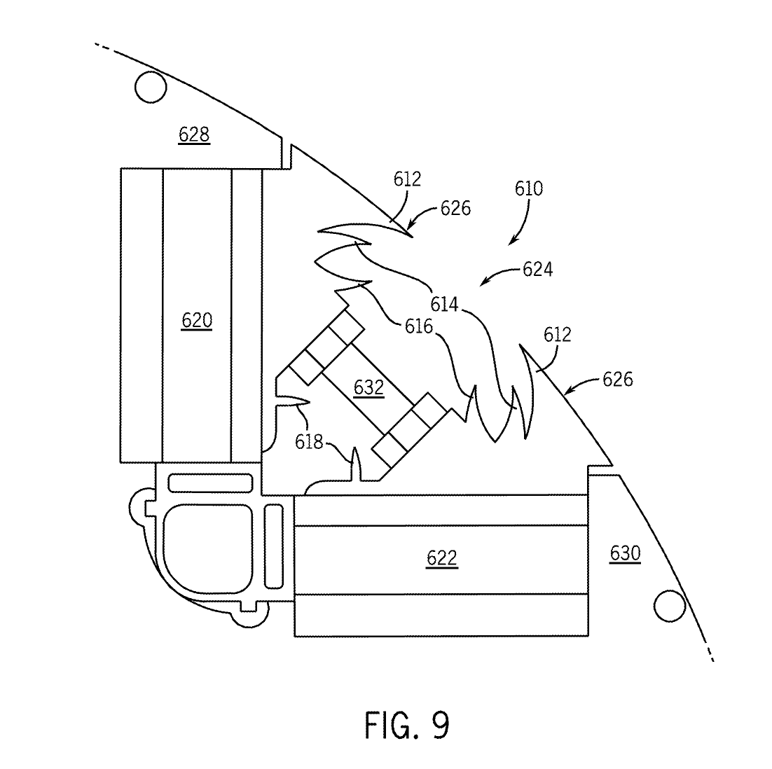

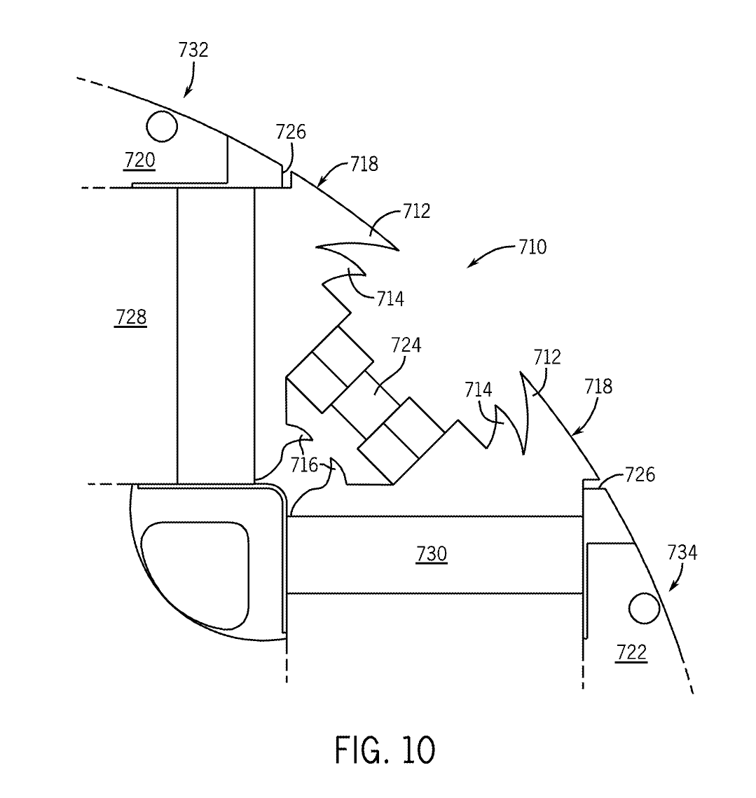

According to an exemplary embodiment, the first and second portions 516, 518 of the element 510 are substantially same-shaped (e.g., identical), but are oriented differently in the element 510. Use of substantially same-shaped first and second portions 516, 518 of the element 510 is believed to allow for easier manufacturing of the first and second portions 516, 518 and assembly of the element 510. The first and second portions 516, 518 of the element 510 may be extruded, die cast, or otherwise formed from a nonferrous material, such as aluminum, ceramic, etc. However, in other embodiments, a first portion has a different shape than a second portion of an element, such as having more or fewer extensions (see, e.g., elements 610, 710 of FIGS. 9-10), differently-shaped extensions (see, e.g., element 610 of FIG. 9), a different thickness or material composition, or other differences, as may facilitate less drag or lower costs of manufacturing.

According to an exemplary embodiment each of the first and second portions 516, 518 of the element 510 include a first side 534, a second side 536, and a third side 538. The first side 534 is configured to constrain coils 530, 532 of a corresponding pole 512, 514. In some embodiments, the first side 534 is substantially flat, while in other embodiments, a first side includes vanes or is otherwise contoured. The second side 536 of each of the first and second portions 516, 518 of the element 510 includes a surface 540 to which the constraining member 520 is coupled. In some exemplary embodiments, an extension 542 (e.g., fin, heat sink, vane) projects from the second side 536. In other exemplary embodiments, more than one extension project from the second side (see, e.g., elements 610, 710 of FIGS. 9-10).

The third side 538 of each of the first and second portions 516, 518 of the element 510 extends along the outer periphery 544 of the rotor assembly and is positioned substantially flush with the arcuate section 546 of a corresponding pole head 526, 528. As such, the third side 538 forms the top or outermost part of each of the first and second portions 516, 518 of the element 510. According to an exemplary embodiment, the third side 538 of the first and second portions 516, 518 is an outside surface of the extension 542 (e.g., heat sinks). The extension 542 projects from the top or outermost part of the second side 536 of the respective one of the first and second portions 516, 518 of the element 510, and extends in the general direction of the other of the first and second portions 516, 518.

Regardless of whether the third side 538 is part of the extension 542 or is simply the top of a pie-shaped element portion, the third side 538 of each of the first and second portions 516, 518 of the element 510 is contoured to complement the curvature of the arcuate section 546 of an adjacent pole head 526, 528. In some embodiments, the periphery 544 of the pole heads 526, 528 and the third sides 538 of the first and second portions 516, 518 of the element 510 combine to form substantially continuous arcs along the outside of the rotor assembly, which in some embodiments are arcs of a constant radius that define the same or substantially the same circle. The contour of the third side 538 of each of the first and second portions 516, 518 of the element 510 is believed to provide a highly efficient geometry for the element 510, reducing windage and drag losses.

Around the periphery 544 of the rotor assembly, an aperture 548 of the element 510 is formed between the third sides 538 of the first and second portions 516, 518 of the element 510. The element 510 further includes an open volume 550 (e.g., air gap) between the first and second portions 516, 518 in the interior of the element 510. According to an exemplary embodiment, the open volume 550 fully extends through the middle of the element 510. The aperture 548 connects to the open volume 550 and allows air to pass into and out of the open volume 550 to transfer heat out of the rotor assembly. The heat may be provided by the coils 530, 532, and may travel through the first and second portions 516, 518, respectively, to the second and third surfaces 536, 538 thereof, for transfer to the air.

According to an exemplary embodiment, the extension 542 of each of the first and second portions 516, 518 of the element 510 serves as a heat sink, providing increased surface area for heat to transfer therefrom into air passing through the aperture 548 and into and out of the open volume 550 of the element 510. Tapering of the geometry of the extension 542 is not required but may enhance the structure of the extension 542. In still other embodiments, the element includes an arcuate outer periphery that is not part of an extension, but instead is solidly connected to the rest of the respective first or second portion of the element, which may be substantially pie-shaped (e.g., a sector of a circle). However, such embodiments provide less surface area to facilitate heat transfer.

Referring to FIG. 9, an element 610 includes more than one extension 612, 614, 616, 618 for facilitating heat transfer away from coils 620, 622 of a rotor assembly and into an air gap 624 of the element 610. The longest extension 612 is coupled to the outermost part of the element 610 and includes an outside surface 626 that blends with the curvature of the corresponding pole head 628, 630. Other extensions 614, 616, 618 of the element 610 are of differing geometries, and are positioned above and below a tensioning member 632 of the element 610.

Similarly in FIG. 10, an element 710 includes several extensions 712, 714, 716 (e.g., heat sinks) extending from the inside surfaces thereof. The outermost extension 712 is longer than the other extensions 714, 716, and includes an outside surface 718 thereof that is substantially of a circular curvature, matching the curvature of the corresponding pole heads 720, 722. The surface 718 of the outermost extension 712 is substantially continuous from the corresponding pole head 720, 722, however small gaps 726 may be formed between the surface 718 and the respective pole head 720, 722. A tensioning member 724 may be used to assemble the element 710 and apply constraining force to coils 728, 730 of the respective poles 732, 734.

According to a contemplated embodiment, rotor poles of a rotor assembly are configured to extend over an open area (see, e.g., open area 424 as shown in FIG. 4) within which an element is to be inserted. The rotor poles extend a circular periphery of the exterior of the rotor assembly further than the rotor poles 420 shown in FIG. 4; and instead of including a flange 430, the rotor poles of such an embodiment extend further over the open area to a distance similar to that of the third sides 538 of the element in FIG. 8 (e.g., 2-degree arc, 5-degree arc, etc.). In such an embodiment, the element is narrowed via a constraining member to be inserted through an air gap (see, e.g., air gap 624 as shown in FIG. 9) between the extended rotor poles. The element is then tightened between the hub and the undersides of the extended rotor poles to secure the coils.

Although shown as wedges in the FIGURES, in other contemplated embodiments, an element is elongate and box shaped, U-shaped forming a cover of the volume between poles with air-gap openings therein, or otherwise shaped. In some embodiments, elements serve to constrain the coils of a rotor—but in other contemplated embodiments, a separate device constrains the coils while the element serves only as an aerodynamic structure to reduce drag or windage of the corresponding rotor assembly during operation of a generator or electric motor.

The construction and arrangements of the generator and components thereof, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A rotor assembly for a generator or a motor, comprising:
a rotor hub;
a first rotor pole;
a second rotor pole, each rotor pole extending from the rotor hub, and each rotor pole comprising:
a winding of conductive wire coupled thereto, and
a pole head positioned on an end of the rotor pole opposite to the hub,
wherein the pole head has an arcuate outer periphery; and
an element positioned between the first and second rotor poles, the element comprising:
an open volume formed therein, and
an aperture on an outside portion of the element, the aperture providing access to the open volume such that air may travel to and from the open volume for cooling of the rotor assembly;
wherein the outside portion of the element is substantially flush with at least one of the pole heads, and is contoured to continuously extend the arcuate outer periphery of the at least one of the pole heads.

2. The rotor assembly of claim 1, wherein the peripheries of the first and second rotor poles define arcs of substantially the same circle.

3. The rotor assembly of claim 2, wherein the outside portion of the element extends along the arc.

4. The rotor assembly of claim 1, wherein the aperture extends longitudinally along the length of the rotor assembly.

5. The rotor assembly of claim 4, wherein the open volume extends through the middle of the element toward the hub.

6. The rotor assembly of claim 1, wherein the element further comprises:
a first portion associated with the first rotor pole;
a second portion associated with the second rotor pole; and
a constraining member coupled intermediate to the first and second portions, wherein the constraining member is configured to load the first and second portions relative to the respective rotor poles.

7. The rotor assembly of claim 6, wherein the first portion and the second portion are substantially same-shaped but oriented differently when assembled in the element.

8. The rotor assembly of claim 7, wherein the constraining member comprises a bolt extending between the first and second portions of the element.

9. An element for a rotor assembly of a generator or a motor, comprising:
a first portion associated with a first rotor pole of the rotor assembly;
a second portion associated with a second rotor pole of the rotor assembly, each portion comprising:
a first side configured to secure a conductive wire winding of the respective rotor pole, and
a second side having an extension projecting therefrom toward the other of the first or second portions, wherein the extension has an arcuate section of the periphery thereof, the arcuate section contoured to continue a rounded periphery of the respective rotor pole; and
a constraining member coupled intermediate to the first and second portions of the element, wherein the constraining member is configured to load the first and second portions relative to the respective rotor poles.

10. The element of claim 9, wherein the first portion and the second portion are substantially same-shaped but oriented differently when assembled in the element.

11. The element of claim 10, wherein the extension of the second side of each portion includes a cross-section that narrows with distance from the respective second side.

12. The element of claim 10, wherein the extension of the second side of each portion is a first extension, and wherein the second side of each portion further includes a second extension projecting therefrom.

13. The element of claim 12, wherein the first extension of the second side of each portion is longer than the corresponding second extension.

14. The element of claim 9, wherein the constraining member comprises a bolt extending between the first and second portions of the element.

15. A generator, comprising:
a stator;
a rotor assembly coupled to the stator and configured to rotate relative thereto, the rotor assembly comprising:
a rotor hub;
a first rotor pole;
a second rotor pole, each rotor pole extending from the rotor hub, and each rotor pole comprising a winding of conductive wire coupled thereto, and a pole head positioned on an end of the rotor pole opposite to the hub, wherein the pole head has an arcuate outer periphery; and
an element comprising a first portion associated with the first rotor pole, a second portion associated with the second rotor pole, and a constraining member coupled intermediate to the first and second portions of the element, wherein the constraining member is configured to load the first and second portions relative to the respective rotor poles, and wherein the first and second portions each comprise:
a first side configured to secure the conductive wire winding of the respective rotor pole, and
a second side having an extension projecting therefrom toward the other of the first or second portions,
wherein the extension has an arcuate section of the periphery thereof, the arcuate section configured to extend the curvature of the arcuate outer periphery of the pole head of the respective rotor pole.

16. The generator of claim 15, wherein the peripheries of the first and second rotor poles define arcs of the same circle.

17. The generator of claim 16, wherein the arcuate section of the periphery of the extension of the second side of each portion of the element extends along the circle.

18. The generator of claim 17, wherein the first portion and the second portion are substantially same-shaped but oriented differently when assembled in the element.

19. The generator of claim 15, wherein the extension of the second side of each portion of the element is a first extension, and wherein the second side of each portion further includes a second extension projecting therefrom.

20. The generator of claim 19, wherein the first extension of the second side of each portion of the element is longer than the corresponding second extension.

21. A generator, comprising:
a stator;
a rotor assembly coupled to the stator and configured to rotate relative thereto, the rotor assembly comprising:
a rotor hub;
a first rotor pole;
a second rotor pole, each rotor pole extending from the rotor hub, and each rotor pole comprising a winding of conductive wire coupled thereto, and a pole head positioned on an end of the rotor pole opposite to the hub, wherein the pole head has an arcuate outer periphery; and
an element positioned between the first and second rotor poles, the element comprising:
an open volume formed therein, and
an aperture on an outside portion of the element, the aperture providing access to the open volume such that air may travel to and from the open volume for cooling of the rotor assembly,
wherein at least one of the element and a pole head comprises an arcuate section configured to extend the curvature of the arcuate outer periphery of the pole head of the respective rotor pole over the open volume formed in the element.

22. The generator of claim 21, wherein the peripheries of the first and second rotor poles define arcs of the same circle.

23. The generator of claim 22, wherein the arcuate section of the at least one of the element and a pole head extends along the circle.

24. The generator of claim 21, wherein the peripheries of the first and second rotor poles and the arcuate section of the at least one of the element and a pole head define circular arcs of the same radius.
